(19) United States
(12) Patent Application Publication
(10) Pub. No.: US 2025/0131408 A1
(43) Pub. Date: Apr. 24, 2025

(54) Electronic Devices and Corresponding Methods for Generating Digital Footprints Defining Locational Surroundings and Environs

(71) Applicant: Motorola Mobility LLC, Chicago, IL (US)

(72) Inventors: Hariprasad Shanbhogue Alampady, Banaglore (IN); Krishnan Raghavan, Bangalore (IN); Amit Kumar Agrawal, Bangalore (IN)

(21) Appl. No.: 18/382,405

(22) Filed: Oct. 20, 2023

(51) Int. Cl. G06Q 20/32

(52) U.S. Cl. CPC G06Q 20/3224; G06Q 20/325; G06Q 20/3278

(57) ABSTRACT

A method in an electronic device includes processing, with one or more processors of the electronic device using a communication device of the electronic device, an electronic financial transaction. The method generates, with the one or more processors using signals from one or more sensors of the electronic device, a digital footprint defining locational surroundings and environs of the electronic device during the processing of the electronic financial transaction. The method monitors, by one or more sensors of the electronic device, the surroundings and environs of the electronic device and presents, by the one or more processors on a user interface, an alert when the surroundings and environs again match the digital footprint defining locational surroundings and environs of the electronic device during the processing of the electronic financial transaction.

### BACKGROUND

### Technical Field

This disclosure relates generally to electronic devices, and more particularly to electronic devices having electronic sensors.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

As these devices begin to be accepted by more and more vendors for financial transactions, both large and small, issues can arise when trying to locate a small, portable business where an electronic device was used for a financial transaction. It would be advantageous to have improved devices and systems to prevent such issues from occurring.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates a user using an electronic device in accordance with one or more embodiments of the disclosure.

FIG. 2 illustrates a prior art method.

FIG. 3 illustrates one or more method steps in accordance with one or more embodiments of the disclosure.

FIG. 4 illustrates one explanatory electronic device in accordance with one or more embodiments of the disclosure.

FIG. 5 illustrates one explanatory method in accordance with one or more embodiments of the disclosure.

FIG. 6 illustrates one or more sensors suitable for use in an electronic device in accordance one or more embodiments of the disclosure.

FIG. 7 illustrates one explanatory electronic device operating in accordance with one or more embodiments of the disclosure.

FIG. 8 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to processing, with one or more processors of an electronic device using a communication device of the electronic device, an electronic financial transaction, generating, using signals from one or more sensors of the electronic device, a digital footprint defining the locational surroundings and environs of the electronic device during the processing of the electronic financial transaction, and associating the digital footprint defining the locational surroundings and environs of the electronic device during the processing of the financial transaction with an electronic record of the electronic financial transaction. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to processing an electronic financial transaction while one or more sensors gather digital footprint data to generate a digital footprint defining the locational surroundings and environs of the electronic device during the processing of the electronic financial transaction, associating the digital footprint defining the locational surroundings and environs of the electronic device occurring during the processing of the electronic financial transaction with an electronic record of the financial transaction, and, when the one or more sensors again detect the surroundings and environs matching the digital footprint data, presenting an electronic financial transaction alert on the user interface of an electronic device as described herein. The non-processor circuits may include, but are not limited to, a radio receiver, a radio transmitter, signal drivers, clock circuits, power source circuits, and user input devices.

As such, these functions may be interpreted as steps of a method to perform generation of a digital footprint defining the locational surroundings and environs of the electronic device during the processing of an electronic financial transaction, monitoring the surroundings and environs of the electronic device, and presenting an alert when the surroundings and environs again match the digital footprint defining the locational surroundings and environs of the electronic device. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide methods and systems for generating a digital footprint defining the locational surroundings and environs of the electronic device during the processing of an electronic financial transaction and associating that digital footprint defining the locational surroundings and environs of the electronic device with an electronic record of the financial transaction. When one or more sensors of the electronic device again detect the surroundings and environs of the electronic device matching the digital footprint data, one or more processors of the electronic device can present an electronic financial transaction alert on the user interface of the electronic device. Advantageously, embodiments of the disclosure allow a person to again locate a merchant with whom a user of the electronic device engaged in an electronic financial transaction by sensing surroundings and environs that match a digital footprint associated with an electronic record of an electronic financial transaction alert.

Embodiments of the disclosure contemplate that many modern electronic devices include financial applications, messaging applications, and shopping applications. Illustrating by example, Motorola Mobility has launched a banking application called DIMO.sup.TM in Brazil. Digital banking applications such as DIMO.sup.TM are redefining banking. Indeed, DIMO.sup.TM already has over one hundred and fifty thousand accounts in Brazil as it grows toward several million accounts.

This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.TM are leading to users simply ceasing to carry paper currency or coins. Moreover, applications like DIMO.sup.TM have caused people to stop carrying physical credit and debit cards as well since the credit and debit card account information can simply be loaded into a smartphone, with near-field and other communication devices allowing direct transactions of money electronically.

Embodiments of the disclosure also contemplate that the acceptance of electronic financial transactions from electronic devices has become so widespread that all types of businesses, from the largest to the smallest, have begun to accept electronic financial transactions initiated from portable electronic devices such as smartphones. Embodiments of the disclosure contemplate that some of these businesses are so small that they may not have a fixed location. Roadside vendors, food truck operators, vending cart operators, and traveling salesmen move around as they sell their wares. Some businesses also operate in shared spaces with several other businesses. These “mobile” businesses are very common in developing countries. However, with the popularity of flea markets, bazaars, music festivals, and communal sales spaces, their number is also increasing in more industrialized nations such as the United States.

Embodiments of the disclosure contemplate that when consumers shop at such places, these mobile businesses provide a great deal of value in that they are convenient, quick, and tend to offer lower prices due to their low overhead costs. However, such mobile businesses also present a unique set of issues, namely, that it can be very difficult for a patron to again locate the business at a later date. While maps or global positioning system (GPS) coordinates allow consumers to find businesses with fixed locations, they are ineffective for mobile businesses.

Accordingly, when a consumer tries to again locate a mobile business it patronized in the past, perhaps to make an exchange or again purchase a beloved good, it can be difficult or impossible to locate some mobile businesses. Compounding the problem, some businesses all look the same, thereby making it even more difficult to again locate a previous vendor.

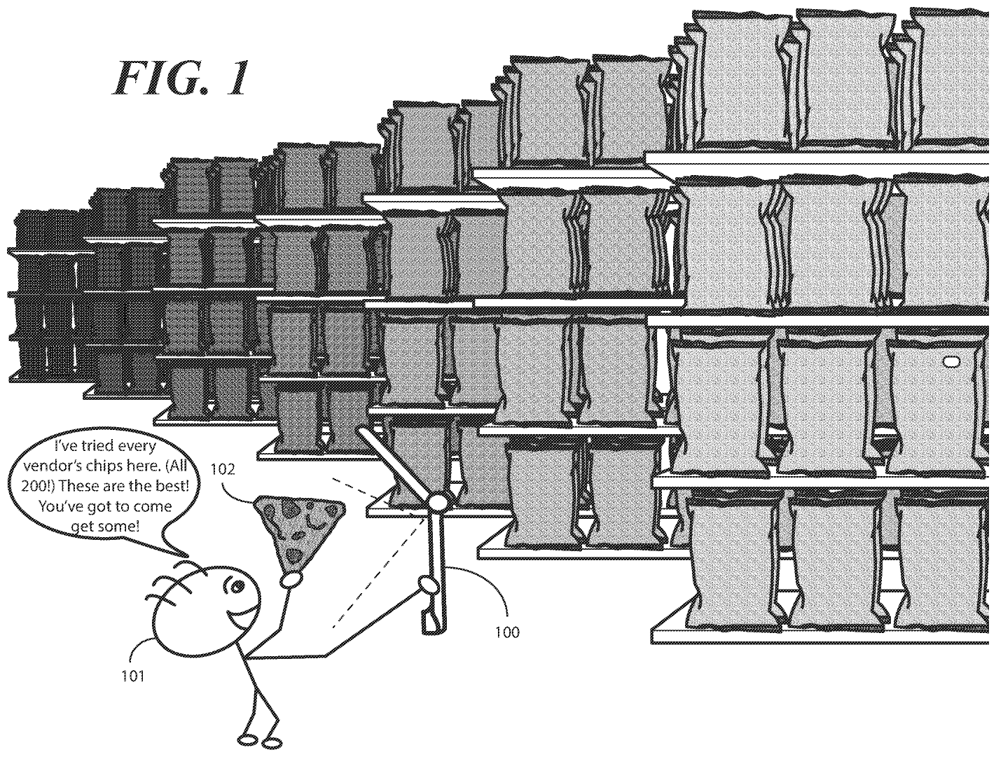

To illustrate by example, turn to FIG. 1. As shown therein, a user 101 of an electronic device 100 is at a corn chip bazaar where over two hundred types of corn chips are for sale by more than eighty different vendors. Each vendor gets a portion of a long aisle upon which it may display its corn chips. However, as shown in FIG. 1, each aisle looks exactly the same.

In the illustrative example of FIG. 1, our dear user has tried every single corn chip from every single vendor. He now believes that he has found the best of the lot 102 and wants to tell a friend to come and buy some before they sell out.

In the illustrative embodiment of FIG. 1, the electronic device 100 is equipped in accordance with embodiments of the disclosure, which makes this proposition trivial. However, had it NOT been configured in accordance with embodiments of the disclosure, problems would most definitely ensue.

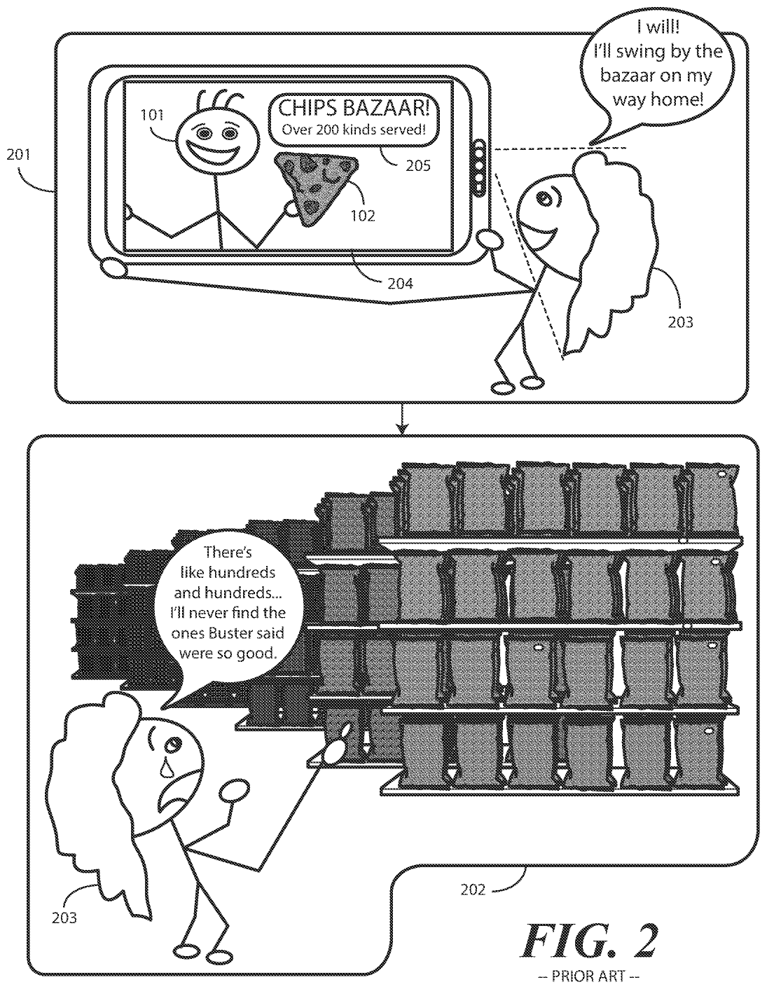

To illustrate how such problems would arise, turn now to FIG. 2 where a prior art method is illustrated. At step 201, our dear user 101 of the electronic device (100) engages in a videoconference 204 with a friend 203 to show of the best of the lot 102 corn chip. He tries to describe where these are at the corn chip bazaar 205, and even gives her the name of the vendor, Mac and Henry, and the name of the chip, the Block One of a Kind chip. Unfortunately, his friend 203 is somewhat forgetful. While she would never forget Block, as it is indeed a one of a kind chip, the friend 203 does forget the numbers and locations and doors and other directions to get to the aisle where the Block One of a Kind chips are located.

As shown at step 202, when she gets to the chip bazaar 205 every single aisle looks exactly the same. Horrified and dismayed, the friend 203 begins to cry as it would take hours and hours to find the Block One of a Kind chip. She laments that there appear to be hundreds and hundreds of chips offered, and that they all look the same. She worries that she will never be able to find the ones our dear user 101, Buster, recommended.

To underscore how problematic such problems can be, consider a few additional examples. Imagine that Will is on a trip to Israel when he visits a shopping street in Jerusalem. Now imagine that Will purchases a couple of antique gifts there and pays the vendor via electronic financial transaction using his smartphone. Will then heads back to his hotel.

Upon arriving his hotel, Will realizes that one of his gifts is broken. He hails a cab to return to the shopping street. Now he suddenly has a real challenge, in that every single ship looks the same and sells similar goods. This leaves Will to spend the next several hours crisscrossing streets in search of the vendor. Sadly, this is all in vain because he's equipped with nothing more than a prior art electronic device. He finally heads back to his hotel room lamenting his ruined luck.

Next consider Manoj who lives in Bangalore. On a sunny day he is exploring a street of shops that all sell mangoes. As he walks through the streets, he homes in on a particular street vendor. Impressed by the quality of this one vendor's mangoes, he buys several kilograms via electronic financial transaction using his smartphone and heads home.

At lunch the next day, Manoj speaks of how delicious the mangoes were and gives a sample to Prasad. Prasad is mightily impressed and becomes ravenously curious about the ship. Manoj knows the street name but cannot accurately describe the shop because there was nothing remarkable about touch input. It was merely one among tens of temporary shops set up on the street. Manoj tells Prasad that there was a middle aged guy running the shop, but also tells Prasad that these shops move around a lot.

Prasad then returns to the same street on a subsequent weekend but just cannot locate the shop. He gives up and is left to purchase mangoes from a different shop. These mangoes are far more expensive and are of a lesser quality. Without the ability to put Manoj in his pocket so as to personally identify the vendor with the delicious, large, supple mangoes, he has no other choice. Embodiments of the disclosure provide a solution to all of this madness. In one or more embodiments, one or more processors of an electronic device detect the engagement of the electronic device in an electronic financial transaction. In one or more embodiments, when this occurs one or more sensors of the electronic device gather information to be compiled into a digital footprint. Examples of such information include surrounding electronic devices having near-field communication capabilities such as Bluetooth.sup.TM (which may include shopkeepers and their assistants using such devices), surrounding Wi-Fi hotspots (which may include hotspots operated by a shopkeeper), the cellular communication signal strength being received by the electronic device, the presence of ultra-wide band (UWB) tags, the presence of near-field communication payment terminals, and images captured by an image capture device, optionally using a wide angle lens in a passive mode without user intervention that captures a background scene when the electronic financial transaction is occurring.

In one or more embodiments, the one or more processors of the electronic device then associate this digital footprint with an electronic record of the financial transaction. The electronic record can be stored as metadata against the electronic financial transaction in the cloud or locally on the electronic device. The digital footprint includes information defining a micro location for each electronic financial transaction so that the same can be located again. In one or more embodiments, the electronic record is able to show all of the digital footprint data associated with a particular electronic financial transaction.

In one or more embodiments, the one or more processors of the electronic device can use the digital footprint to allow a user to again locate a vendor where an electronic financial transaction occurred. This is true even when the vendor is moving. In one or more embodiments, when the one or more sensors of the electronic device again detect locational surroundings and environs matching those of the digital footprint, perhaps when a user activates a predefined mode of operation such as an “automatic payment location” mode, the user can begin roaming to find the exact vendor with whom a previous electronic financial transaction was processed. In one or more embodiments, the electronic device delivers haptic feedback in the form of a buzz or other haptic output when the electronic device again returns to the exact vendor with whom the electronic financial transaction was made.

Advantageously, with the popularity of digital payment method increasing, combined with the fact that many businesses are mobile, embodiments of the disclosure allow a person to again locate a merchant with whom they have done business. While finding a prior merchant is one advantage offered by embodiments of the disclosure, embodiments of the disclosure are not so limited. The digital footprints and digital footprint data described herein could also be used for other applications such as security to document where a person took certain actions and so forth. Other advantages will be described below. Still others will be obvious to those of ordinary skill in the art having the benefit of this disclosure.

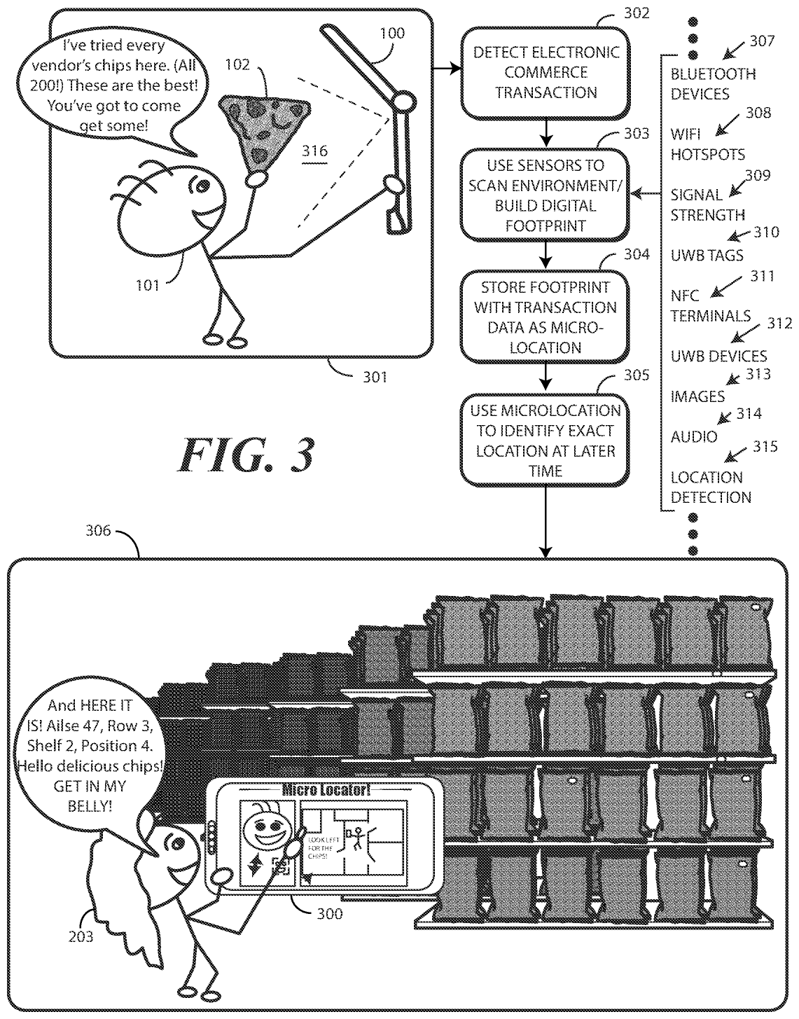

To illustrate just how advantageous embodiments of the disclosure are, turn now to FIG. 3 where at step 301 our dear user 101 is again reveling in the fact that the found the best of the lot 102 at the chip bazaar (205), namely, the Block One of a Kind chip. Fortunately for both the user 101 and his friend 203, both are using electronic devices 100,300 configured in accordance with one or more embodiments of the disclosure.

At step 301, the user 101 purchases a bag of the Block One of a Kind chips by engaging in an electronic financial transaction with the vendor at the chip bazaar (205). At step 302, the one or more processors of the electronic device 100 process the electronic financial transaction.

At step 303, the one or more processors of the electronic device 100 generate, using signals from one or more sensors of the electronic device, a digital footprint defining the locational surroundings and environs of the electronic device during the processing of the financial transaction. As noted above, the information used to build the digital footprint defining the locational surroundings and environs of the electronic device can vary.

Illustrating by example, in one or more embodiments the digital footprint data used to generate the digital footprint defining the locational surroundings and environs of the electronic device comprises short-range communication signals received from one or more short-range wireless communication devices 307 situated within the environs 316 of the electronic device 100. Examples of such short-range wireless communication devices 307 include electronic devices equipped with Bluetooth.sup.TM communication capabilities or other similar short-range communication capabilities.

In other embodiments, the digital footprint data used to generate the digital footprint defining the locational surroundings and environs of the electronic device comprises local-area network wireless communication devices 308 situated within the environs 316 of the electronic device 100. Examples of such local-area network wireless communication devices 308 include Wi-Fi hotspots and other network communication terminal devices.

In still other embodiments, the digital footprint data used to generate the flexible display defining the locational surroundings and environs of the electronic device comprises wide-area network communication signals 309 received from one or more wide-area network wireless communication devices situated within the environs 316 of the electronic device 100. Illustrating by example, a received signal strength indicator (RSSI) measured by the electronic device 100 can be used as a proxy to determine a locational relationship to one or more terrestrial cellular communication towers, and so forth.

In still other embodiments, the digital footprint data used to generate the digital footprint defining the locational surroundings and environs of the electronic device comprises ultra-wide band signals received from one or more ultra-wide band communication devices 310 situated within the environs 316 of the electronic device 100. In still other embodiments, the digital footprint data used to generate the digital footprint defining the locational surroundings and environs of the electronic device comprises near-field communication signals received from one or more near-field wireless communication devices 311 or ultra-wide band communication devices 312.

In still other embodiments, an image capture device of the electronic device 100 can be configured to passively (without user intervention) capture one or more images 313 depicting the surroundings and environs of the electronic device 100 when an electronic financial transaction is processed. An audio capture device can capture audio signals 314 to make a record of particular voices or other sounds when an electronic financial transaction is made. A location detector can detect location 315 as well.

While these various digital footprint data can be used alone, it should be noted that they could also be used in combination in various embodiments as well. Illustrating by example, a digital footprint may include data from one or more Bluetooth.sup.TM devices, a RSSI measurement, data from a near-field communication terminal, and a passively captured image depicting the environs 316 of the electronic device 100 in one embodiment. By contrast, another digital footprint may comprise acoustic data recording the vendor's voice, the identifier of a Wi-Fi hotspot operated by a vendor, and a record of an ultra-wide band device identifier that was within the environs 316 of the electronic device 100. Other combinations of digital footprint data suitable for identifying the surroundings and environs of the electronic device 100 when an electronic financial transaction is made will be obvious to those of ordinary skill in the art having the benefit of this disclosure.

At step 304 the one or more processors of the electronic device 100 associate the digital footprint defining the locational surroundings and environs of the electronic device 100 during the processing of the electronic financial transaction with an electronic record of the financial transaction. In one or more embodiments, step 304 comprises storing the digital footprint defining the locational surroundings and environs of the electronic device in the metadata of the electronic record to create a footprinted electronic record.

At step 304, the one or more processors of the electronic device 100 use the digital footprint to again locate the merchant with which the electronic financial transaction processed at step 302 occurred. This step 305 can occur in a variety of ways.

When the user 101 of electronic device 100 wants to locate the merchant from whom the Block One of a Kind chip was purchased, in one or more embodiments step 305 comprises the user interface of the electronic device 100 receiving user input initiating a micro-locator mode of operation. When this occurs, step 305 comprises the one or more processors of the electronic device retrieving, in response to the user input, the digital footprint defining the locational surroundings and environs of the electronic device during the processing of the electronic financial transaction from a memory of the electronic device 100.

Thereafter, one or more sensors of the electronic device 100 can monitor the surroundings and environs of the electronic device 100 at step 305. When the surroundings and environs again match the digital footprint defining the locational surroundings and environs of the electronic device 100 during the processing of the electronic financial transaction, the one or more processors of the electronic device 100 can present an alert on a user interface of the electronic device 100 at step 305. For instance, the one or more processors can cause the user interface of the electronic device 100 to deliver a haptic response in the form of a buzz or bump so that the user 101 understands that they are again in a location matching the digital footprint. In one or more embodiments, the alert identifies the electronic financial transaction.

In the illustrative example of FIG. 3, the user 101 wants his friend 203 to be able to find this magical Block One of a Kind chip. Accordingly, the digital footprint created in electronic device 100 must be transferred to electronic device 300. Thus, in this illustrative embodiment step 305 comprises using the communication device of the electronic device 100 to transmit the digital footprint defining the locational surroundings and environs of the electronic device to another electronic device 300 across a network.

As shown at step 306, this allows the one or more sensors of electronic device 300 to monitor the surroundings and environs of electronic device 300. When the surroundings and environs of electronic device 300 match the surroundings and environs of electronic device 100 when the electronic financial transaction was processed at step 301, the one or more processors of electronic device 300 present an alert on a user interface of electronic device 300.

As shown at step 306, this advantageously allows the friend 203 to determine that the Block One of a Kind chips are located at aisle forty-seven, row three, shelf two, position four. Amazed by embodiments of the disclosure, and elated at the prospect of finding Block, the friend 203 exclaims “get in my belly, chips!”

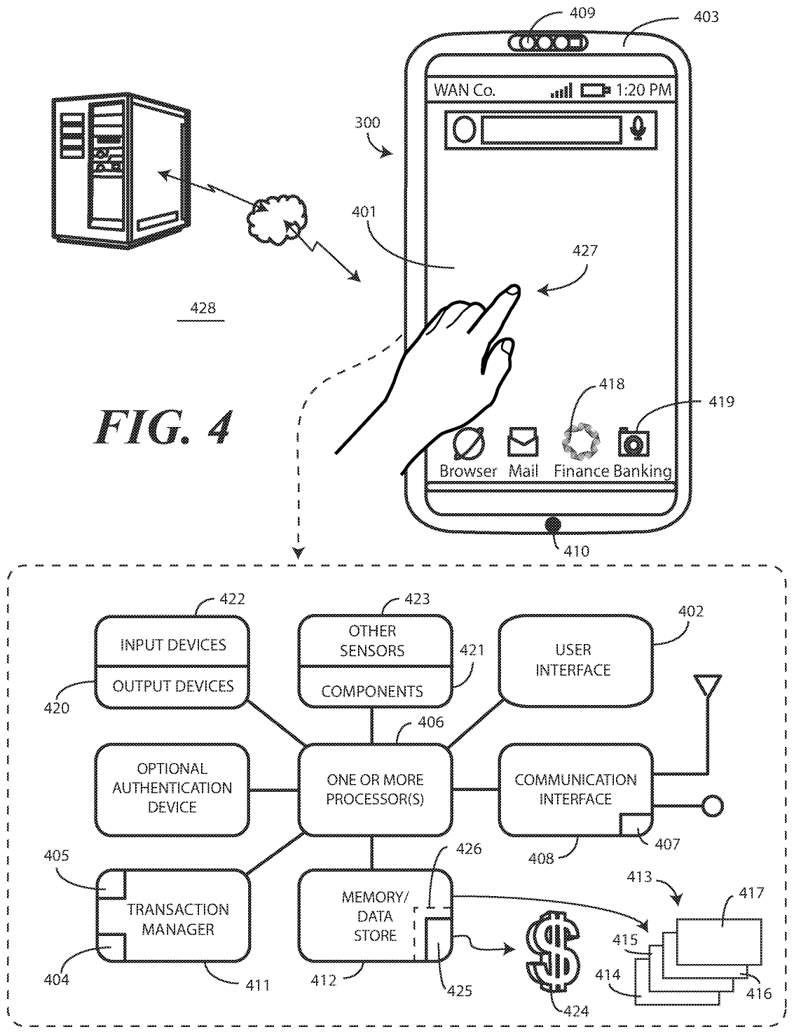

Turning now to FIG. 4, illustrated therein is one explanatory electronic device 300 configured in accordance with one or more embodiments of the disclosure. As shown, the electronic device 300 includes one or more sensors 423, a user interface 402, and a communication device 408. One or more processors 406 are operable with the one or more sensors 423, the user interface 402, and the communication device 408.

In one or more embodiments, the one or more processors 406 are configured to, in response to processing an electronic financial transaction 424 while the one or more sensors 423 gather digital footprint data 404 to generate a digital footprint 405 defining locational surroundings and environs of the electronic device 300 occurring during the processing of the electronic financial transaction 424, associate the digital footprint 405 defining the locational surroundings and environs of the electronic device 300 occurring during the processing of the electronic financial transaction 424 with an electronic record 425 of the electronic financial transaction 424, and, when the one or more sensors 423 again detect the surroundings and environs of the electronic device 300 matching the digital footprint data 404, present an electronic financial transaction alert, one example of which is shown in FIG. 7 below, on the user interface 402. In one or more embodiments, the electronic financial transaction alert indicates that a present location of the electronic device 300 is where the financial transaction 424 previously occurred.

In one or more embodiments, the user interface 402 comprises a display 401, which may optionally be touch-sensitive. The display 401 can serve as a primary user interface 402 of the electronic device 300.

Where the display 401 is touch sensitive, users can deliver user input to the display 401 by delivering touch input from a finger, stylus, or other objects disposed proximately with the display. In one embodiment, the display 401 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 300 of FIG. 4 includes a housing 403. Features can be incorporated into the housing 403. Examples of features that can be included along the housing 403 include an imager 409, shown as a camera in FIG. 4, or an optional speaker port. A user interface component 410, which may be a button or touch sensitive surface, can also be disposed along the housing 403.

A block diagram schematic of the electronic device 300 is also shown in FIG. 4. In one embodiment, the electronic device 300 includes one or more processors 406. In one embodiment, the one or more processors 406 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device. The application processor and the auxiliary processor(s) can be operable with the various components of the electronic device 300. Each of the application processor and the auxiliary processor(s) can be configured to process and execute executable software code to perform the various functions of the electronic device 300. A storage device, such as memory 412, can optionally store the executable software code used by the one or more processors 406 during operation.

In this illustrative embodiment, the electronic device 300 also includes a communication device 408 that can be configured for wired or wireless communication with one or more other devices or networks. The networks can include a wide area network, a local area network, and/or personal area network. The communication device 408 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology.

The communication device 408 can include wireless communication circuitry, one of a receiver, a transmitter, or transceiver, and one or more antennas. In one or more embodiments, when a digital footprint 405 is to be shared with another electronic device as described above with reference to FIG. 3, the communication device 408 can be configured to transmit the digital footprint 405 defining the locational surroundings and environs of the electronic device to another electronic device across a network.

The electronic device 300 can optionally include a near field communication circuit 407 used to exchange data, power, and electrical signals between the electronic device 300 and another electronic device. In one embodiment, the near field communication circuit 407 is operable with a wireless near field communication transceiver, which is a form of radio-frequency device configured to send and receive radio-frequency data to and from the companion electronic device or other near field communication objects.

Where included, the near field communication circuit 407 can have its own near field communication circuit controller in one or more embodiments to wirelessly communicate with companion electronic devices using various near field communication technologies and protocols. The near field communication circuit 407 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 406 can be responsible for performing the primary functions of the electronic device 300. Illustrating by example, the one or more processors 406 can be configured to associate the digital footprint 405 defining the locational surroundings and environs of the electronic device by writing the digital footprint 405 defining the locational surroundings and environs of the electronic device to metadata 426 of a digital record 425 of an electronic financial transaction 424.

In one or more embodiments, the one or more processors 406 comprise one or more circuits operable to present presentation information, such as images, text, and video, on the display 401. The executable software code used by the one or more processors 406 can be configured as one or more modules 413 that are operable with the one or more processors 406. Such modules 413 can store instructions, control algorithms, and so forth.

In one embodiment, the one or more processors 406 are responsible for running the operating system environment 414. The operating system environment 414 can include a kernel, one or more drivers, and an application service layer 415, and an application layer 416. The operating system environment 414 can be configured as executable code operating on one or more processors or control circuits of the electronic device 300.

The application service layer 415 can be responsible for executing application service modules. The application service modules may support one or more applications 417 or “apps.” Examples of such applications 417 include a cellular telephone application for making voice telephone calls, a web browsing application configured to allow the user to view webpages on the display 401 of the electronic device 300, an electronic mail application configured to send and receive electronic mail, a photo application configured to organize, manage, and present photographs on the display 401 of the electronic device 300, and a camera application for capturing images with the imager 409. Collectively, these applications constitute an “application suite.”

In one or more embodiments, these applications comprise one or more financial applications 418 and/or banking applications 419 that allow financial transactions to be made using the electronic device 300. Illustrating by example, in one or more embodiments a user can deliver user input to a financial application 418 or a banking application 419 to initiate a financial transaction initiation communication to complete a financial transaction 424 with a merchant. In one or more embodiments, when this occurs several things can happen. For example, the one or more sensors 423 of the electronic device 300 can gather digital footprint data 404 so that the one or more processors 406 can generate a digital footprint 405 defining the locational surroundings and environs of the electronic device 300 during the processing of the financial transaction 424. Additionally, the communication device 408 can transmit a financial transaction initiation communication generated by a transaction manager 411.

In one or more embodiments, the transaction manager 411 is operable with the one or more processors 406. In some embodiments, the one or more processors 406 can control the transaction manager 411. In other embodiments, the transaction manager 411 can operate independently, delivering information gleaned from detecting multi-modal social cues, emotional states, moods, and other contextual information to the one or more processors 406. The transaction manager 411 can receive data from the various sensors. In one or more embodiments, the one or more processors 406 are configured to perform the operations of the transaction manager 411.

In one or more embodiments, the one or more processors 406 are responsible for managing the applications and all personal information received from the user interface 402 that is to be used by the finance application 418 and/or banking application 419 after the electronic device 300 is authenticated as a secure electronic device and the user identification credentials have triggered a login event. The one or more processors 406 can also be responsible for launching, monitoring and killing the various applications and the various application service modules. In one or more embodiments, the one or more processors 406 are operable to not only kill the applications, but also to expunge any and all personal data, data, files, settings, or other configuration tools when the electronic device 300 is reported stolen to wipe the memory 412 clean of any personal data, preferences, or settings of the person previously using the electronic device 300.

The one or more processors 406 can also be operable with other components 421 and other sensors 423. The other components 421, in one embodiment, include input components 422, which can include acoustic detectors as one or more microphones. The one or more processors 406 may process information from the other components 421 alone or in combination with other data, such as the information stored in the memory 412 or information received from the user interface.

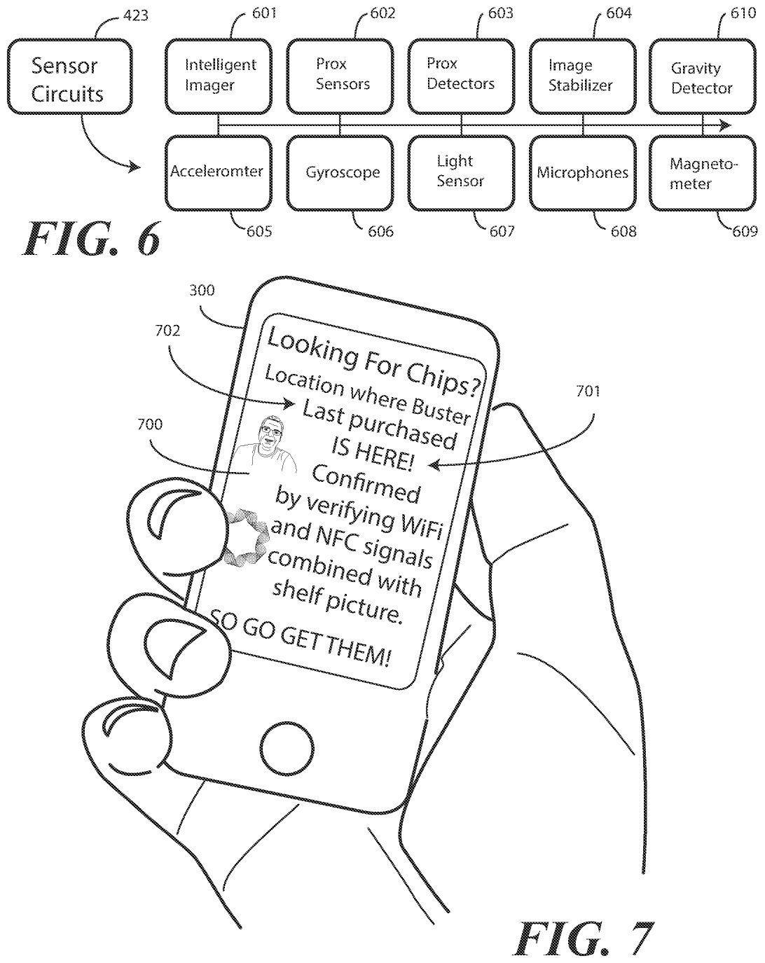

Various sensors 423 can be operable with the one or more processors 406 as well. These sensors 423 can be used to gather digital footprint data 404 so that the one or more processors 406 can generate a digital footprint 405 corresponding to an electronic financial transaction 424. Turning briefly to FIG. 6, illustrated therein are some examples of the sensors 423 that can be included with an electronic device configured in accordance with embodiments of the disclosure. Others will be obvious to those of ordinary skill in the art having the benefit of this disclosure.

The sensors 423 of FIG. 6 can be operable—alone or in combination—with the one or more processors (406) of the electronic device (300) in accordance with one or more embodiments of the disclosure. It should be noted that the sensor circuits 423 shown in FIG. 6 are not comprehensive, as others will be obvious to those of ordinary skill in the art having the benefit of this disclosure. Additionally, it should be noted that the various sensor circuits 423 shown in FIG. 6 could be used alone or in combination. Accordingly, many electronic devices will employ only subsets of the sensor circuits 423 shown in FIG. 6, with the particular subset defined by device application.

An intelligent imager 601 can be configured to capture an image of environments about an electronic device and determine whether the object matches predetermined criteria. For example, the intelligent imager 601 operate as an identification module configured with optical recognition such as include image recognition, character recognition, visual recognition, facial recognition, color recognition, shape recognition and the like. This information can be included with the digital footprint data (404) used to create a digital footprint (405) associated with an electronic financial transaction (424). Advantageously, the intelligent imager 601 can recognize whether a user's face or eyes are oriented toward the display (401) or another major surface of the electronic device (300), whether a user is gazing toward the display (401) or another major surface of the electronic device (300), or spatially where a user's eyes or face are located in three-dimensional space relative to the electronic device (300). In one or more embodiments, the intelligent imager 601 can also be used to capture surroundings and environs of an electronic device (300) when an electronic financial transaction (424) is occurring.

In addition to capturing photographs, the intelligent imager 601 can function in other ways to collect digital footprint data (404) as well. For example, in some embodiments the intelligent imager 601 can capture multiple successive pictures to capture more information that can be used to determine bearing and/or location when an electronic financial transaction (424) is occurring. By referencing video or successive photographs with reference data, the intelligent imager 601 can determine, for example, what a merchant's shop or staff or wares look like. Alternatively, the intelligent imager 601 can capture images or video frames, with accompanying metadata such as motion vectors. This additional information captured by the intelligent imager 601 can be used to detect bearing and/or location data for electronic financial transactions (424).

In one embodiment, the sensor circuits 423 can include one or more proximity sensors. The proximity sensors can include one or more proximity sensor components 602. The proximity sensor components 602 can also include one or more proximity detector components 603. In one embodiment, the proximity sensor components 602 comprise only signal receivers. By contrast, the proximity detector components 603 include a signal receiver and a corresponding signal transmitter.

While each proximity detector component 603 can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components 603 comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components 602. The proximity detector components 603 can have signal receivers that receive similar wavelengths, i.e., about 860 nanometers.

In one or more embodiments the proximity sensor components 602 have a longer detection range than do the proximity detector components 603 due to the fact that the proximity sensor components 602 detect heat directly emanating from a person's body (as opposed to reflecting off the person's body) while the proximity detector components 603 rely upon reflections of infrared light emitted from the signal transmitter. For example, the proximity sensor component 602 may be able to detect a person's body heat from a distance of about ten feet, while the signal receiver of the proximity detector component 603 may only be able to detect reflected signals from the transmitter at a distance of about one to two feet.

In one embodiment, the proximity sensor components 602 comprise an infrared signal receiver so as to be able to detect infrared emissions from a person. Accordingly, the proximity sensor components 602 require no transmitter since objects disposed external to the housing (403) of the electronic device (300) deliver emissions that are received by the infrared receiver. As no transmitter is required, each proximity sensor component 602 can operate at a very low power level. Evaluations show that a group of infrared signal receivers can operate with a total current drain of just a few microamps (˜10 microamps per sensor). By contrast, a proximity detector component 603, which includes a signal transmitter, may draw hundreds of microamps to a few milliamps.

In one embodiment, one or more proximity detector components 603 can each include a signal receiver and a corresponding signal transmitter. The signal transmitter can transmit a beam of infrared light that reflects from a nearby object and is received by a corresponding signal receiver. The proximity detector components 603 can be used, for example, to compute the distance to any nearby object from characteristics associated with the reflected signals. In one or more embodiments, these measurements are made when an electronic financial transaction (424) is occurring to collect digital footprint data (404). The reflected signals are detected by the corresponding signal receiver, which may be an infrared photodiode used to detect reflected light emitting diode (LED) light, respond to modulated infrared signals, and/or perform triangulation of received infrared signals.

Another possible sensor circuit 423 used to collect digital footprint data (404) is a near field communication circuit 604. The near field communication circuit 604 can be included for communication with other electronic devices, local area networks, and so forth to receive information relating to electronic financial transactions (424) the electronic device (300) may initiate. Illustrating by example, the near field communication circuit 604 may poll other communication circuits when the electronic financial transaction (424) is occurring to help gather digital footprint data (404) to determine the identity of the merchant with which the electronic financial transaction (424) is being made. Examples of suitable near field communication circuits include Bluetooth communication circuits, IEEE 801.11 communication circuits, infrared communication circuits, magnetic field modulation circuits, and Wi-Fi circuits.

The sensor circuits 423 can also include motion detectors, such as one or more accelerometers 605, and/or gyroscopes 606. For example, an accelerometer 605 may be used to show vertical orientation, constant tilt and/or whether the electronic device (300) is stationary. The measurement of tilt relative to gravity is referred to as “static acceleration,” while the measurement of motion and/or vibration is referred to as “dynamic acceleration.” A gyroscope 606 can be used in a similar fashion.

The motion detectors can also be used to determine the spatial orientation of the electronic device (300) as well in three-dimensional space by detecting a gravitational direction 610. This can determine, for example, whether the display (401) of the electronic device (300) is pointing downward to the earth or laterally to a user's eyes. In addition to, or instead of, an accelerometer 605 and/or gyroscope 606, an electronic compass can be included to detect the spatial orientation of the electronic device (300) relative to the earth's magnetic field. Similarly, the gyroscope 606 can be included to detect rotational motion of the electronic device (300).

A light sensor 607 can detect changes in optical intensity, color, light, or shadow in the environment of an electronic device (300). This can be used to make inferences about whether an electronic financial transaction (424) is being transacted indoors or outdoors by determining whether ambient light is being received. For example, if the light sensor 607 detects low-light conditions this could mean that the electronic financial transaction (424) is occurring indoors. An infrared sensor can be used in conjunction with, or in place of, the light sensor 607. The infrared sensor can be configured to detect thermal emissions from an environment about an electronic device, such as when sunlight is incident upon the electronic device.

A magnetometer 608 can be included as well. The magnetometer 608 can be configured to detect the presence of external magnetic fields. Illustrating by example, the magnetometer 608 can be used to determine whether an electronic financial transaction (424) is being transacted with an electronic device using strong electromagnetic signals. This information may indicate that the other electronic device is nearby, rather than remote for example.

The sensor circuits 423 can also include an audio capture device 609, such as one or more microphones to receive acoustic input. The one or more microphones can be used to sense voice input, voice commands, and other audio input. The one or more microphones include a single microphone.

In other embodiments, the one or more microphones can include two or more microphones. Where multiple microphones are included, they can be used for selective beam steering to, for instance, determine from which direction a sound emanated. Illustrating by example, a first microphone can be located on a first side of the electronic device (300) for receiving audio input from a first direction, while a second microphone can be placed on a second side of the electronic device (300) for receiving audio input from a second direction. The one or more processors (406) can then select between the first microphone and the second microphone to determine where the user is located in three-dimensional space relative to the electronic device (300).

It should be noted that the illustrative sensor circuits 423 of FIG. 6 are not comprehensive. Numerous others could be added. Accordingly, the sensor circuits 423 of FIG. 6 are illustrative only, as numerous others will be obvious to those of ordinary skill in the art having the benefit of this disclosure.

Turning now back to FIG. 4, the one or more sensors 423 can comprise other sensors as well. A first example of a sensor that can be included with the sensors 423 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 406, to detect an object in close proximity with—or touching—the surface of the display 401 or the housing of an electronic device 300 by establishing electric field lines between pairs of capacitive sensors and then detecting perturbations of those field lines.

Another example of a sensor 423 is a geo-locator that serves as a location detector. In one embodiment, location detector is able to determine location data by capturing the location data from a constellation of one or more earth orbiting satellites, or from a network of terrestrial base stations to determine an approximate location. Examples of satellite positioning systems suitable for use with embodiments of the present invention include, among others, the Navigation System with Time and Range (NAVSTAR) Global Positioning Systems (GPS) in the United States of America, the Global Orbiting Navigation System (GLONASS) in Russia, and other similar satellite positioning systems. The satellite positioning systems based location fixes of the location detector autonomously or with assistance from terrestrial base stations, for example those associated with a cellular communication network or other ground based network, or as part of a Differential Global Positioning System (DGPS), as is well known by those having ordinary skill in the art. The location detector may also be able to determine location by locating or triangulating terrestrial base stations of a traditional cellular network, such as a CDMA network or GSM network, or from other local area networks, such as Wi-Fi networks.

A gaze detector can be included with the one or more sensors 423 and can comprise sensors for detecting the user's gaze point. The gaze detector can include an iris scanner. The gaze detector can optionally include sensors for detecting the alignment of a user's head in three-dimensional space. Electronic signals can then be processed for computing the direction of user's gaze in three-dimensional space. The gaze detector can further be configured to detect a gaze cone corresponding to the detected gaze direction, which is a field of view within which the user may easily see without diverting their eyes or head from the detected gaze direction. The gaze detector can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector.

Other components 421 operable with the one or more processors 406 can include output components 420 such as video, audio, and/or mechanical outputs. For example, the output components 420 may include a video output component or auxiliary devices including a cathode ray tube, liquid crystal display, plasma display, incandescent light, fluorescent light, front or rear projection display, and light emitting diode indicator. Other examples of output components 420 include audio output components such as a loudspeaker disposed behind a speaker port or other alarms and/or buzzers and/or a mechanical output component such as vibrating or motion-based mechanisms.

The other components 421 can optionally include a barometer operable to sense changes in air pressure due to elevation changes or differing pressures of the electronic device 300 when an electronic financial transaction 424 is occurring. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

Similarly, a temperature sensor can be configured to monitor temperature about an electronic device. The other components 421 can also include a flash. The other components 421 can also include a fingerprint sensor or retina scanner.

In one or more embodiments, the one or more processors 406, optionally working in conjunction with the transaction manager 411, are configured to process an electronic financial transaction 424 and generate, using signals from the one or more sensors 423, a digital footprint 405 defining the locational surroundings and environs of the electronic device 300 during the processing of the electronic financial transaction 424. In one or more embodiments, the one or more processors 406 and/or transaction manager 411 are configured to associate the digital footprint 405 defining the locational surroundings and environs of the electronic device 300 with an electronic record 425 of the electronic financial transaction 424. Where the digital footprint 405 needs to be shared with another electronic device, the one or more processors 406 and/or transaction manager 411 can cause the communication device 408 to transmit the digital footprint 405 to a remote electronic device across a network. When the digital footprint defining the locational surroundings and environs of the electronic device 300 during the processing of the electronic financial transaction 424 is associated with metadata 426 of the electronic record 425, this creates a footprinted electronic record.

To assist a user of the electronic device 300 in again locating a merchant with whom the electronic financial transaction 424 was made, in one or more embodiments the one or more processors 406 and/or transaction manager 411 is configured to use the one or more sensors 423 to sense digital footprint data 404 to generate the digital footprint 405 defining the locational surroundings and environs of the electronic device 300 during the processing of the electronic financial transaction 424.

When user input 427 is received by the user interface 402 of the electronic device initiating a micro-locator mode of operation, the one or more processors 406 retrieve the digital footprint 405 defining the locational surroundings and environs of the electronic device 300. The one or more processors 406 then monitor, using the one or more sensors 423 of the electronic device 300, the surroundings and environs 428 of the electronic device. When the surroundings and environs 428 again match the digital footprint 405 defining the locational surroundings and environs of the electronic device 300 during the processing of the electronic financial transaction 424, the one or more processors 406 cause the user interface 402 to present an alert, one example of which is shown in FIG. 7 below. In one or more embodiments, the alert causes the user interface 402 to deliver a haptic response as previously described. In one or more embodiments, the alert identifies the electronic financial transaction 424.

It is to be understood that FIG. 4 is provided for illustrative purposes only and for illustrating components of one electronic device 300 in accordance with embodiments of the disclosure and is not intended to be a complete schematic diagram of the various components required for an electronic device. Therefore, other electronic devices in accordance with embodiments of the disclosure may include various other components not shown in FIG. 4 or may include a combination of two or more components or a division of a particular component into two or more separate components, and still be within the scope of the present disclosure.

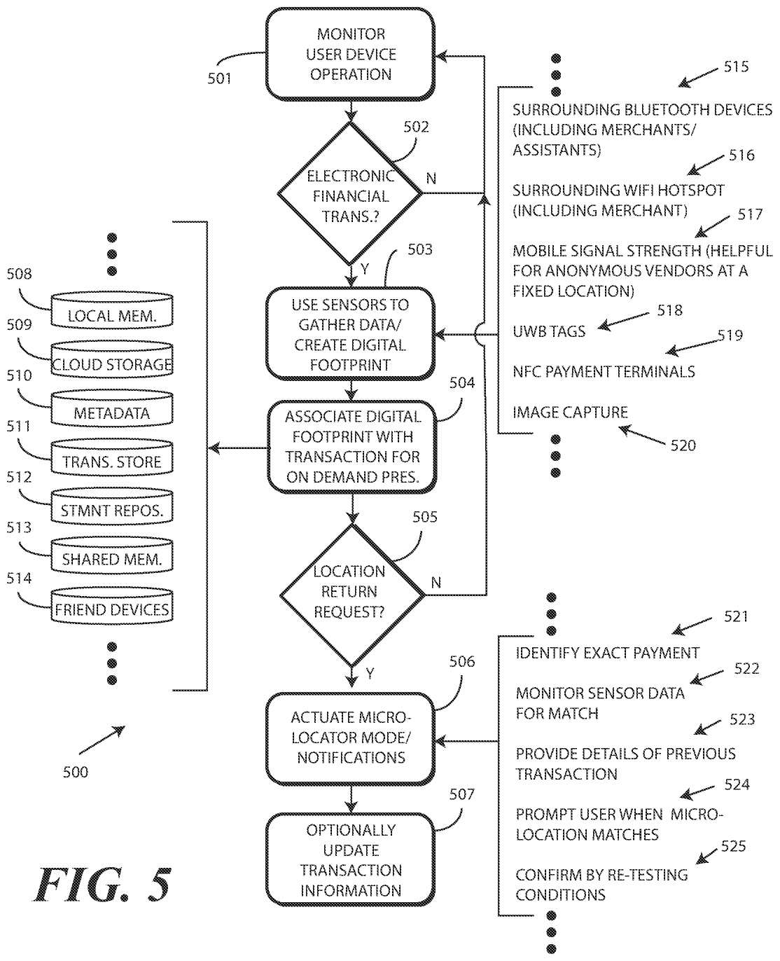

Turning now to FIG. 5, illustrated therein is another method 500 configured in accordance with one or more embodiments of the disclosure. Beginning at step 501, one or more processors of an electronic device monitor user operation of the electronic device. In one or more embodiments, decision 502 comprises the one or more processors monitoring to detect whether an electronic financial transaction is occurring.

When this is the case, at step 503 the one or more processors use one or more sensors of the electronic device to gather digital footprint data. In one or more embodiments, the digital footprint data collected at step 503 comprises short-range communication signals received from one or more short-range wireless communication devices 515. situated within the environs of the electronic device. In other embodiments, the digital footprint data collected at step 503 comprises local-area network communication signals received from one or more local-area network wireless communication devices 516 situated within the environs of the electronic device.

In still other embodiments, the digital footprint data collected at step 503 comprises wide-area network communication signals 517 received from one or more wide-area network wireless communication devices situated within the environs of the electronic device. In other embodiments, the digital footprint data collected at step 503 comprises ultrawideband signals received from one or more ultrawideband communication devices 518 situated within the environs of the electronic device.

In still other embodiments, the digital footprint data collected at step 503 comprises near-field communication signals received from one or more near-field wireless communication devices 519 situated within the environs of the electronic device. In still other embodiments, the digital footprint data collected at step 503 comprises one or more images 520 captured of the environs of the electronic device. Of course, this digital footprint data can be collected alone or in combination. Once the digital footprint data is collected, step 503 comprises generating, with the one or more processors in response to execution of an electronic financial transaction, a digital footprint defining the locational surroundings and environs of the electronic device during the electronic financial transaction.

At step 504, the one or more processors associate the digital footprint defining the locational surroundings and environs of the electronic device during the processing of the electronic financial transaction with an electronic record of the electronic financial transaction. In one or more embodiments, this step 504 comprises storing the digital footprint defining the locational surroundings and environs of the electronic device during the processing of the electronic financial transaction in metadata 510 of the electronic record to create a footprinted electronic record. The footprinted electronic record can then be stored in any of a variety of locations, examples of which include a local memory 508 of the electronic device, cloud storage 509, an electronic financial transaction database 511, an electronic financial transaction statement repository 512, or a shared memory 513 between multiple electronic devices. Step 504 can also comprise transmitting the footprinted electronic record to a remote electronic device 514 across a network.

Decision 505 then monitors the surroundings and environs of the electronic device using one or more sensors of the electronic device. Where the surroundings and environs again match the digital footprint defining the locational surroundings and environs of the electronic device during the processing of the electronic financial transaction, at step 506 the one or more processors of the electronic device present an alert on the user interface.

The alert can comprise various information. In one or more embodiments, the alert identifies the payment amount 521 of the electronic financial transaction. The alert can indicate that the electronic device is situated where the electronic financial transaction occurred by detecting that the sensor data 522 matches the digital footprint. The alert can provide details 523 of the electronic financial transaction. The alert can also be a haptic alert 524 that prompts a user that the location where the electronic device is situates matches the digital footprint. To confirm that there is indeed a match, the one or more sensors can perform a confirmation operation 525. Transaction information can be updated at step 507 if another electronic financial transaction occurs in the location.

Turning now to FIG. 7, illustrated therein is one example of such an alert 700. As shown, the alert 700 identifies the electronic financial transaction by noting that the location 701 of the electronic device 300 is indeed the location where the electronic financial transaction 702 occurred. In this illustrative example, the alert 700 indicates how this determination was made, which is via Wi-Fi signals and NFC signals combined with image data. The illustrative alert 700 of FIG. 7 even includes a call to action for the user to engage in a similar- or the same-electronic financial transaction as that which previously occurred. Other examples of alerts will be obvious to those of ordinary skill in the art having the benefit of this disclosure.

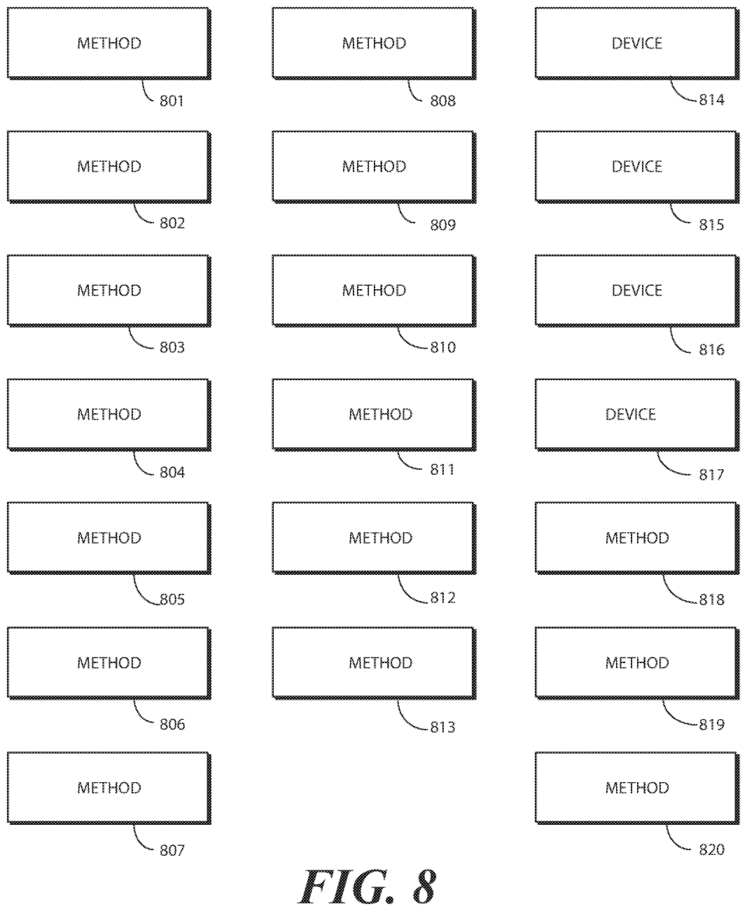

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in an electronic device comprises processing, with one or more processors of the electronic device using a communication device of the electronic device, an electronic financial transaction. At 801, the method comprises generating, with the one or more processors using signals from one or more sensors of the electronic device, a digital footprint defining locational surroundings and environs of the electronic device during the processing of the electronic financial transaction. At 801, the method comprises associating the digital footprint defining the locational surroundings and environs of the electronic device during the processing of the electronic financial transaction with an electronic record of the electronic financial transaction.

At 802, the associating of 801 comprises storing the digital footprint defining the locational surroundings and environs of the electronic device during the processing of the electronic financial transaction in metadata of the electronic record to create a footprinted electronic record. At 803, the method of 802 further comprises transmitting, with the communication device, the footprinted electronic record to a remote electronic device across a network.

At 804, the method of 801 further comprises sensing, with the one or more sensors of the electronic device, digital footprint data to generate the digital footprint defining the locational surroundings and environs of the electronic device during the processing of the electronic financial transaction. At 805, the digital footprint data of 804 comprises short-range communication signals received from one or more short-range wireless communication devices situated within the environs of the electronic device.

At 806, the digital footprint data of 804 comprises local-area network communication signals received from one or more local-area network wireless communication devices situated within the environs of the electronic device. At 807, the digital footprint data of 804 comprises wide-area network communication signals received from one or more wide-area network wireless communication devices situated within the environs of the electronic device.

At 808, the digital footprint data of 804 comprises ultrawideband signals received from one or more ultrawideband communication devices situated within the environs of the electronic device. At 809, the digital footprint data of 804 comprises near-field communication signals received from one or more near-field wireless communication devices situated within the environs of the electronic device. At 810, the digital footprint data of 804 comprises one or more images captured of the environs of the electronic device.

At 811, the method of 804 further comprises receiving, by a user interface of the electronic device, user input initiating a micro-locator mode of operation. At 811, the method comprises retrieving, by the one or more processors in response to the user input, the digital footprint defining locational surroundings and environs of the electronic device during the processing of the electronic financial transaction.

At 811, the method comprises monitoring, by the one or more sensors of the electronic device, the surroundings and environs of the electronic device. At 811, the method comprises presenting, by the one or more processors on the user interface, an alert when the surroundings and environs again match the digital footprint defining locational surroundings and environs of the electronic device during the processing of the electronic financial transaction.

At 812, the presenting the alert at 811 comprises causing, by the one or more processors, the user interface to deliver a haptic response. At 813, the alert of 811 identifies the electronic financial transaction.

At 814, an electronic device comprises one or more sensors, a communication device, a user interface, and one or more processors operable with the one or more sensors, the communication device, and the user interface. At 814, the one or more processors are configured to, in response to processing an electronic financial transaction while the one or more sensors gather digital footprint data to generate a digital footprint defining locational surroundings and environs of the electronic device occurring during the processing of the electronic financial transaction, associate the digital footprint defining the locational surroundings and environs of the electronic device occurring during the processing of the electronic financial transaction with an electronic record of the electronic financial transaction, and, when the one or more sensors again detect the surroundings and environs of the electronic device matching the digital footprint data, present an electronic financial transaction alert on the user interface.

At 815, the electronic financial transaction alert of 814 indicates that a present location of the electronic device is where the electronic financial transaction previously occurred. At 816, the communication device of 814 is configured to transmit the digital footprint defining the locational surroundings and environs of the electronic device to another electronic device across a network. At 817, the one or more processors of 814 are configured to associate the digital footprint defining the locational surroundings and environs of the electronic device by writing the digital footprint defining the locational surroundings and environs of the electronic device to metadata of a digital record of the electronic financial transaction.

At 818, a method in an electronic device comprises generating, with one or more processors in response to execution of an electronic financial transaction, a digital footprint defining locational surroundings and environs of the electronic device occurring during the electronic financial transaction. At 818, the method comprises associating the digital footprint defining the locational surroundings and environs of the electronic device during the processing of the electronic financial transaction with an electronic record of the electronic financial transaction.

At 818, the method comprises monitoring, by one or more sensors of the electronic device, the surroundings and environs of the electronic device. At 818, the method comprises presenting, by the one or more processors on a user interface, an alert when the surroundings and environs again match the digital footprint defining locational surroundings and environs of the electronic device during the processing of the electronic financial transaction.

At 819, the location of the electronic device of 818 when the digital footprint defining locational surroundings and environs of the electronic device was generated and another location where the surroundings and environs again match the digital footprint defining locational surroundings and environs of the electronic device are different. At 918, the alert identifies that a counterparty of the electronic financial transaction who was present at the location is present at the other location. At 820, the alert of 819 indicates the electronic device is situated where the electronic financial transaction occurred.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

What is claimed is:

1. A method in an electronic device, the method comprising:
processing, with one or more processors of the electronic device using a communication device of the electronic device, an electronic financial transaction;
generating, with the one or more processors using signals from one or more sensors of the electronic device, a digital footprint defining locational surroundings and environs of the electronic device during the processing of the electronic financial transaction; and
associating the digital footprint defining the locational surroundings and environs of the electronic device during the processing of the electronic financial transaction with an electronic record of the electronic financial transaction.

2. The method of claim 1, wherein the associating comprises storing the digital footprint defining the locational surroundings and environs of the electronic device during the processing of the electronic financial transaction in metadata of the electronic record to create a footprinted electronic record.

3. The method of claim 2, further comprising transmitting, with the communication device, the footprinted electronic record to a remote electronic device across a network.

4. The method of claim 1, further comprising sensing, with the one or more sensors of the electronic device, digital footprint data to generate the digital footprint defining the locational surroundings and environs of the electronic device during the processing of the electronic financial transaction.

5. The method of claim 4, wherein the digital footprint data comprises short-range communication signals received from one or more short-range wireless communication devices situated within the environs of the electronic device.

6. The method of claim 4, wherein the digital footprint data comprises local-area network communication signals received from one or more local-area network wireless communication devices situated within the environs of the electronic device.

7. The method of claim 4, wherein the digital footprint data comprises wide-area network communication signals received from one or more wide-area network wireless communication devices situated within the environs of the electronic device.

8. The method of claim 4, wherein the digital footprint data comprises ultrawideband signals received from one or more ultrawideband communication devices situated within the environs of the electronic device.

9. The method of claim 4, wherein the digital footprint data comprises near-field communication signals received from one or more near-field wireless communication devices situated within the environs of the electronic device.

10. The method of claim 4, wherein the digital footprint data comprises one or more images captured of the environs of the electronic device.

11. The method of claim 4, further comprising:
receiving, by a user interface of the electronic device, user input initiating a micro-locator mode of operation;
retrieving, by the one or more processors in response to the user input, the digital footprint defining locational surroundings and environs of the electronic device during the processing of the electronic financial transaction;
monitoring, by the one or more sensors of the electronic device, surroundings and environs of the electronic device; and
presenting, by the one or more processors on the user interface, an alert when the surroundings and environs again match the digital footprint defining locational surroundings and environs of the electronic device during the processing of the electronic financial transaction.

12. The method of claim 11, wherein the presenting the alert comprises causing, by the one or more processors, the user interface to deliver a haptic response.

13. The method of claim 11, wherein the alert identifies the electronic financial transaction.

14. An electronic device, comprising:
one or more sensors;
a communication device;
a user interface; and
one or more processors operable with the one or more sensors, the communication device, and the user interface;
wherein the one or more processors are configured to, in response to processing an electronic financial transaction while the one or more sensors gather digital footprint data to generate a digital footprint defining locational surroundings and environs of the electronic device occurring during the processing of the electronic financial transaction, associate the digital footprint defining the locational surroundings and environs of the electronic device occurring during the processing of the electronic financial transaction with an electronic record of the electronic financial transaction, and, when the one or more sensors again detect surroundings and environs of the electronic device matching the digital footprint data, present an electronic financial transaction alert on the user interface.

15. The electronic device of claim 14, wherein the electronic financial transaction alert indicates that a present location of the electronic device is where the electronic financial transaction previously occurred.

16. The electronic device of claim 14, wherein the communication device is configured to transmit the digital footprint defining the locational surroundings and environs of the electronic device to another electronic device across a network.

17. The electronic device of claim 14, wherein the one or more processors are configured to associate the digital footprint defining the locational surroundings and environs of the electronic device by writing the digital footprint defining the locational surroundings and environs of the electronic device to metadata of a digital record of the electronic financial transaction.

18. A method in an electronic device, the method comprising:
generating, with one or more processors in response to execution of an electronic financial transaction, a digital footprint defining locational surroundings and environs of the electronic device occurring during the electronic financial transaction;
associating the digital footprint defining the locational surroundings and environs of the electronic device during the processing of the electronic financial transaction with an electronic record of the electronic financial transaction;
monitoring, by one or more sensors of the electronic device, surroundings and environs of the electronic device; and
presenting, by the one or more processors on a user interface, an alert when the surroundings and environs again match the digital footprint defining locational surroundings and environs of the electronic device during the processing of the electronic financial transaction.

19. The method of claim 18, wherein:
a location of the electronic device when the digital footprint defining locational surroundings and environs of the electronic device was generated and another location where the surroundings and environs again match the digital footprint defining locational surroundings and environs of the electronic device are different; and
the alert identifies that a counterparty of the electronic financial transaction who was present at the location is present at the another location.

20. The method of claim 19, wherein the alert indicates the electronic device is situated where the electronic financial transaction occurred.
